(19) United States
(12) Patent Application Publication
(10) Pub. No.: US 2018/0349372 A1
(43) Pub. Date: Dec. 6, 2018

(54) MEDIA ITEM RECOMMENDATIONS BASED ON SOCIAL RELATIONSHIPS

(71) Applicant: Apple Inc., Cupertino, CA (US)

(72) Inventors: Baris Dundar, Moraga, CA (US); Venkatakrishnan Sundaranatha, San Jose, CA (US); Jayasimha Reddy Katukuri, San Jose, CA (US); Chandrasekar Venkataraman, Palo Alto, CA (US); Rabi Chakraborty, San Jose, CA (US); Drew Rocky Domm, Oakland, CA (US); Matthew Joseph Cielak, San Francisco, CA (US); Taylor G. Carrigan, San Francisco, CA (US); William Martin Bachman, San Jose, CA (US); Fredric Vinnå, Stockholm (SE); Ofer Morag, Oakland, CA (US)

(21) Appl. No.: 15/872,929

(22) Filed: Jan. 16, 2018

Related U.S. Application Data
(60) Provisional application No. 62/514,228, filed on Jun. 2, 2017.

(51) Int. Cl. G06F 17/30

(52) U.S. Cl. CPC G06F 17/30029; G06Q 50/01; G06F 17/30053; G06F 17/30058

(57) ABSTRACT

The present technology recommends media items (albums, playlists, and other groupings) based on media items that have been recently played back within a user's social graph. The present technology determines accounts with the user's social graph have the most similar taste in media items, and have the most similar engagement with media items, and selects these users from which to favor media item recommendations. Additionally, the recommendations can be ranked according to compatibility with the user's taste in media items.

### CROSS REFERENCE TO RELATED APPLICATIONS

This application claims priority to U.S. provisional application No. 62/514,228, filed on Jun. 2, 2017, which is expressly incorporated by reference herein in its entirety.

### TECHNICAL FIELD

The present technology relates to media item recommendations, and more specifically to recommendations of media items recently played back by members of a social relationships.

### BACKGROUND

Music is an important part of interpersonal relationships, and one of the best ways to learn music is through one's interpersonal relationships. Because of this fact some technologies display songs that have recently been played back by members of a user's social network. However, such technologies give too much importance to the influence of the social network and many of the songs that are displayed are irrelevant to the user.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 shows an example system in accordance with some aspects of the present technology;

FIG. 2 shows an example method in accordance with some aspects of the present technology;

FIG. 3 shows an example method in accordance with some aspects of the present technology;

FIG. 4 shows example sources of data used in determining a taste profile for a user account in accordance with some aspects of the present technology;

FIG. 5 shows example latent taste profile scores of artists for a user account in accordance with some aspects of the present technology;

FIG. 6 shows an example method in accordance with some aspects of the present technology;

FIG. 7 shows a block diagram of an example user representation database in accordance with some aspects of the present technology;

FIG. 8 shows an example of data store in user representation database in accordance with some aspects of the present technology;

FIG. 9 shows an example of individual queries for representations similar to an input representation database in accordance with some aspects of the present technology;

FIG. 10 shows an example of media item recommendation and badges in accordance with some aspects of the present technology;

FIG. 11 shows an example method in accordance with some aspects of the present technology;

FIG. 12 shows an example matrix displaying distance measurements between compact representations of user accounts in accordance with some aspects of the present technology:

FIG. 13 shows an example visualization showing the relative similarity amongst user accounts social graph accordance with some aspects of the present technology; and

FIG. 14 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The disclosed technology addresses the need in the art to provide media recommendations that while influenced by a user account's social network, the recommendations also take into account the user account's taste in that media. For example, some media services do present media items played back by people in a user account's social network, but many of these media items presented to the user account are irrelevant to the user account. They are irrelevant because the presented media items do not reflect the user account's taste. Such services fail to take into account the account's taste in at least two ways. First, such services fail to recognize that a user account's social graph can be wide ranging, and many of the members of that social graph may not share a particularly strong interpersonal relationship with the user of the user account, and more to the point, many of the members of that social graph may not share the same taste in media items as the user of the user account. Second, such services fail to recognize that even members of the social graph that have similar taste in media items as the user account do not have the same taste in media items and at least some media items played back by members of the social graph that have similar taste in media items as the user account will be irrelevant to the user account.

The present technology improves upon the above-described shortcomings of the present technology. For example the present technology can quickly determine members of a user account's social graph that have similar taste in media items to the profile of the user account and limit media items suggestions to only members of the social graph that have the most similar taste in media items. The present technology also recognizes and accounts for the fact that a person's taste in media items changes over time so determining members of the social graph that have the most similar taste in media items should be re-determined frequently. The present technology also filters media item suggestions to remove media items that are clearly not of interest to a user profile. Additionally, the present technology also recognizes that media items that have been experienced most recently are often of the most relevance and therefore, the present technology can prioritize such media items when making social recommendations. Even in view of the fact that the present technology takes into account these complicated factors, the present technology can provide social recommendations in an online process occurring in near real-time.

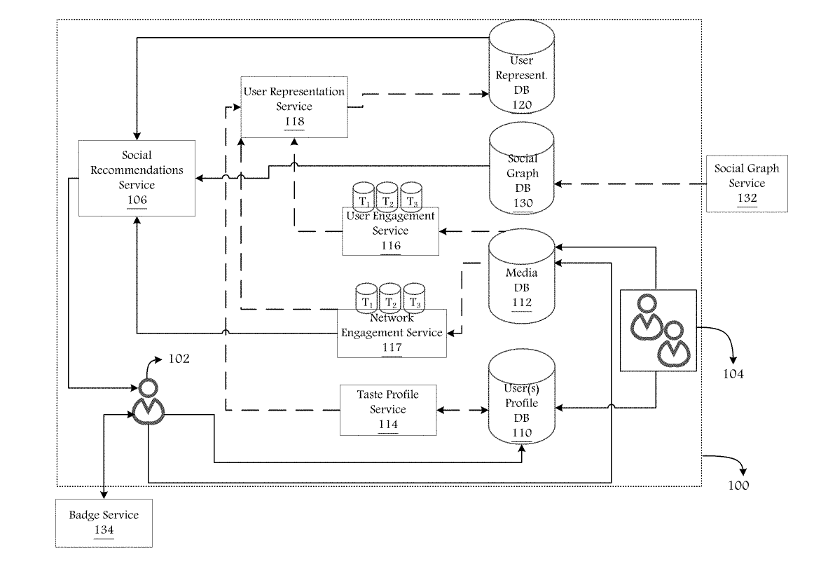

FIG. 1 illustrates an example system embodiment of the present technology. FIG. 1 is an example system for providing socially influenced recommendations to user 102. User 102 operates a client device such as a laptop, personal computer, smart phone, tablet, etc. to interface with other entities illustrated in FIG. 1.

The socially influenced recommendations are derived from playback history of relevant members of users 104. Users 104 is representative of a population of users of media service 100.

Media service 100 stores user profile information in user profile database 110 for user 102 and users 104. Information stored in user profile database 110 can include user account identifiers, demographic information, payment information, records of media items purchased by or stored in user accounts, etc. in some embodiments user profile database 110 can also include additional information such as declared preferences (perhaps received during user account on boarding), followed artists (some embodiments users can select artists to follow and view public postings by those artists), and any other information.

Media service 100 also stores media playback data and interaction data in media database 112. For example media database 112 can include a listing of all media items played back by user accounts of media service 100. The listing of all media items played back by user accounts of media service 100 can include media items played from a user's media library, or media items played from a radio service or on-demand subscription service. The listing of all media items played back can also be associated with interaction data such as skip information, like, and dislikes of media item.

While user profile database 110 and media database 112 have been described with respect to specific types of data stored within the respective databases, persons of ordinary skill in the art will appreciate that all information described herein could be scored in one database or could be stored in more databases than those described or depicted in FIG. 1.

The information stored in user profile database 110 and media database 112 can be used to determine user taste profiles and user item engagement profiles for user account 102 and each of user accounts 104 of media service 100. These profiles are then used to determine a representation for each of users 104 and user 102 which can be used to determine similarity representations between multiple users 104 and user 102, which then can be used to generate candidate media items, such as albums, playlists, and other collections of media items to be recommended to user 102 by social recommendations service 106. In some embodiments, candidate media items can include songs.

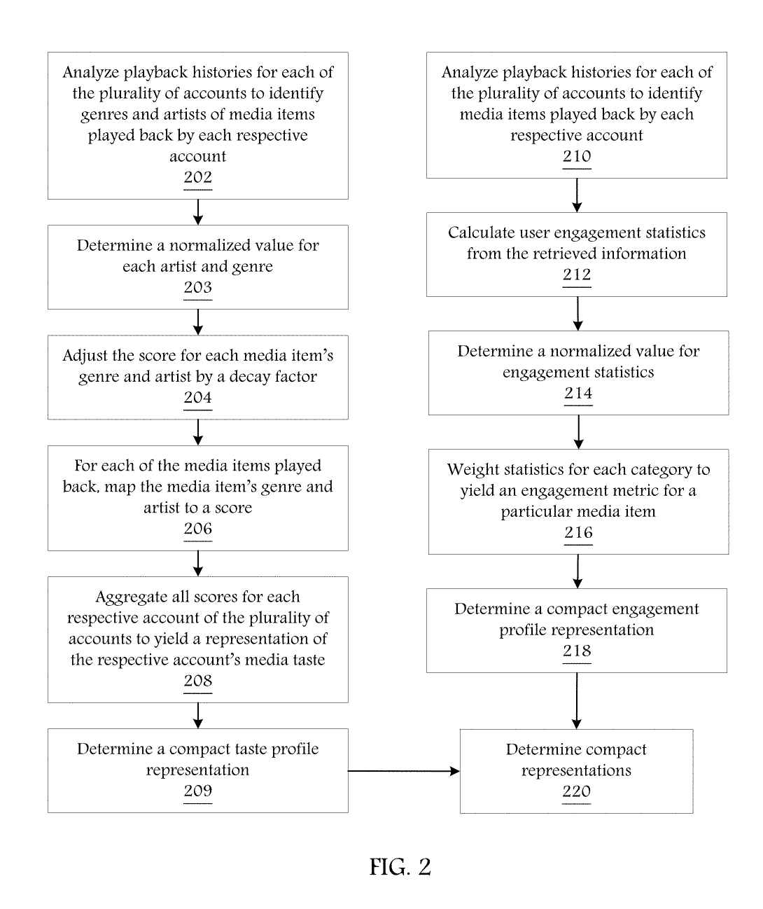

FIG. 2 illustrates an example method embodiment consistent with the present technology. Description of FIG. 2 will be made with reference to elements of FIG. 1. Although, the embodiment of FIG. 1 is merely illustrative.

As addressed above, an aspect of the present technology is to be able to identify a subset of users 104 that have a similar representation to that of user 102. User representations can consist of both a summary of a user's taste profile and a summary of the user's recent playback history or engagement with media service 100. Broadly, FIG. 2 illustrates an example method of determining a taste profile representation for users of media service 100 in steps 202, 203, 204, 206, 208, and 209, and illustrates an example method of determining an engagement profile representation for users of media service 100 in steps 210, 212, 214, 216, and 218. The taste profile representation and engagement profile representations can be combined into a compact representation at step 220.

User's taste profiles can be determined by taste profile service 114 which can retrieve information stored in association with respective users' accounts and can analyze (202) the retrieved information.

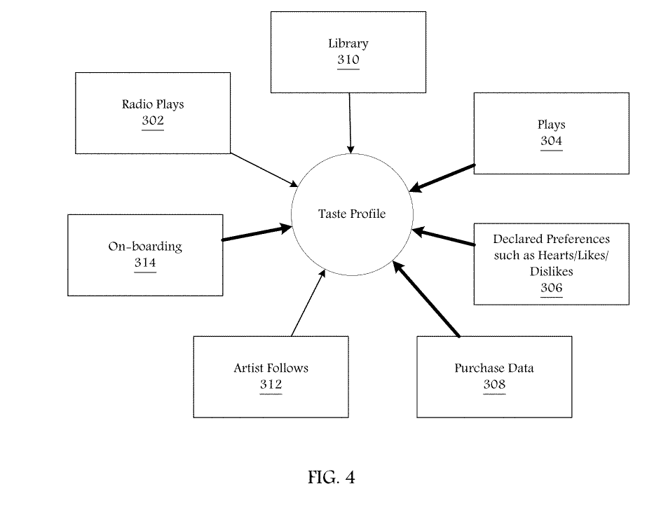

In general, the retrieved taste profile information is information that is relevant to users taste in media, and while in some cases it might be derived from specific played back media items, it does not reflect the actual media items played back by the user account (this data is used to determine the engagement profile). An example of the retrieved taste profile information is illustrated in FIG. 4. For example FIG. 4 shows that a taste profile can be made up of media item playbacks from radio 302 or the user's media library or a subscription service 304, information regarding media items purchased or added to a media library 308, information regarding media items in a media library 310, information regarding artists that a user has chosen to follow 312, and information regarding declared information such as e.g., hearts, likes 306, information provided by the user during on boarding 314 or creation of the user account or implied preferences (song skips which might indicate dislikes). FIG. 4 also illustrates arrows with different line weights, which indicate a possible relative importance of such data in determining a taste profile. For example, in some embodiments, plays 304, declared preferences 306, 314, and purchase data 308 are more important than what media items are in a user account media library 310, what media items have been played back via a radio service 302, etc. The relative importance of a data source can manifest itself in weighting factors whereby the more important sources of data receive higher weights.

Weighting factors, and relatedly, which data sources are considered most important can be chosen based on which data is the most statically significant (e.g., best sample size, regression analysis or machine learning points to a data source being a good indicator of media item taste).

While FIG. 4 illustrates a variety of classifications of retrieved taste profile information, persons of ordinary skill in the art will appreciate that more or less varieties of retrieved information are possible.

While FIG. 2 addresses retrieved taste profile information such as playback histories (202), it should be appreciated that this is by way of example only, and similar techniques as discussed with respect to FIG. 2 will apply to all the examples of possible retrieved information in FIG. 4, or other types of information as will be appreciated by persons of ordinary skill in the art.

Additionally while FIG. 1 illustrates taste profile service 114 in communication with user profile database 110 to retrieve taste profile information, persons of ordinary skill in the art will appreciate that taste profile service 114 can be in communication with a variety of other sources.

Returning to FIG. 2, taste profile service 114 can analyze (202) taste profile information retrieved from user profile database 110. One example type of taste profile information includes playback histories. For each of the plurality of accounts stored in user profile database 110, taste profile service 114 can analyze the playback histories to identify media items played back by each respective account.

For each of the media items in the playback history, taste profile service can identify an associated artist and genre, etc. Both of these taste attributes can be normalized, aggregated, and then combined with other taste attributes.

This can be done, for example, by identifying a specific artist associated with a media item in the playback history of the user account, and determining (203) the percentage of all media items played back in the playback history of the user account that belong to that specific artist to achieve a normalized value for the user account's preference for that specific artist for that source of data.

In some embodiments, taste profile service can also determine an adventurousness ranking for a user account. This can determined from a declared interest of the user account, or by analyzing the playback history of a user account to determine a ratio of media items that are played back outside of a user's favorite genres, or how often a user account plays back media items that it has not played back before.

In some embodiments, the age of the data can be accounted for through a decay factor. For example, data derived for a media item that was played back a month ago can be weighted by a decay factor to reduce the relevance of the aged data on the calculated taste profile.

Other sources of data can also be analyzed (such as likes and dislikes, and other sources illustrated in FIG. 4, etc.) to contribute to determining a user account's preference for that specific artist. The data derived from each source of data can be weighted (204) according to how meaningful the data is considered (as addressed above some data sources are considered more statistically significant) and aggregated to yield a score for the user account's preference for that specific artist.

This technique can be repeated for each artist found in the user account's playback history.

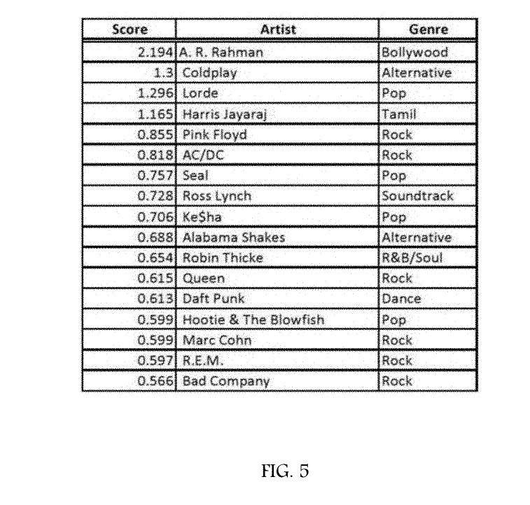

FIG. 5 is a table illustrating a listing of scores representing a user accounts relative preference for some artists. As illustrated the artist “A.R. Rahman” has a score of 2.194, and “Coldplay” has a score of 1.3, which indicates this user account's taste profile strongly favors these artists; this user account also favors “Bad Company,” but not to the degree of “A.R. Rahman” and “Coldplay.”

The specific artist can be mapped (206) to a random number or identifier. The identifier or number can be randomly chosen, however once chosen, the identifier or number should remain consistent for the same artist. In some embodiments the mapping can be performed using locality sensitive hashing techniques. In such embodiments each media item belonging to a particular artist can be hashed to a number, identifier, or bucket.

The identifier or number for that specific artist can by multiplied by the score for that user's account preference for that artist to yield a compact score for that specific artist that is more easily and meaningfully aggregable. The compact scores for all artists are aggregated.

The technique described above is also utilized to determine a compact score for genre, or any other dimension in the data that is of interest.

After aggregated compact scores are determined for artists, genres and any other dimension in the data that is of interest, taste profile service 114 can aggregate (208) all the scores or numbers to yield (209) a compact taste profile representation. The taste profile representation can be further hashed or compressed using a thresholding operation to determine (209) a compact taste profile representation.

In addition to determining a taste profile for each user of media service 100, media service 100 also determines user engagement profiles for each user of media service 100. The user engagement profile is descriptive of media items that users of media service 100 have played back including a number of times playing back a media item, the time spent with that media item, and when the media item is a collection, the percentage of that collection that has been played back.

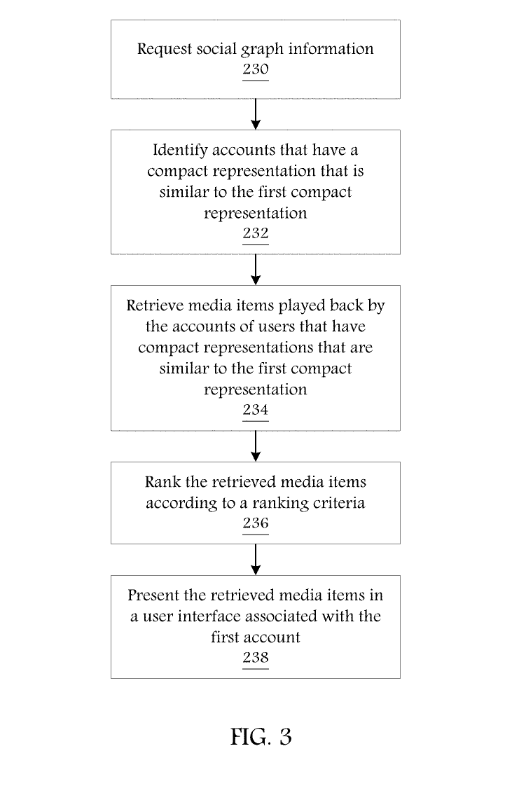

FIG. 1 illustrates user engagement service 116 and network engagement service 117. User engagement service 116 and network engagement service 117 are similar or can be the same service, but are broken out in FIG. 1 for illustrative purposes to differentiate user engagement data from user accounts 104 in recommending media items to user account 102 in FIG. 3. However, engagement service 116 and network engagement service 117 can perform the same functions and are discussed together with respect to FIG. 2.

Both engagement services 116 and 117 are illustrated having three collections of media items which are three different time buckets (T₁, T₂, T₃). One time bucket for media items just played back, for example within the last five or 10 minutes. Another time bucket is for media items played back recently, for example within the last few weeks. The last time bucket is historical for media items played back further in the past. These time buckets can be used to weight data derived from playback histories to give less influence to older data. For example, the relevance of the data stored in historical bucket can be associated with an exponential decay function that would give data derived from media items stored in the historical bucket ½ the weight after data is aged by two months, to give data aged four months ¼ of the weight, to give data aged 6 months ⅛ the weight and so forth.

User's engagement profiles can be determined by engagement services 116, 117 which can retrieve information stored in association with respective users' accounts and can analyze (FIG. 2, item 210) the retrieved information.

For each media item, engagement service 116, 117 can calculate (FIG. 2, item 212) user engagement statistics from the retrieved information. Example statistics include number of plays of a media item by user, time spent playing back a media item by user, and percentage of tracks of a media item played back by user. Some of the statistics need to be normalized (214) for example the statistics regarding number of plays of the media item by a user should be normalized to reflect the ratio between the number of plays of media item over the total number of plays of all media items by user. Likewise the statistic for time spent listening to a media item by user should be normalized to be a ratio over a total time spent listening to media items by the user.

The statistics for each category are then weighted (216) to yield an engagement metric for a particular media item. The user engagement score for a media item can be determined by the equation listed below where UE(u,i) is the engagement score for a user for a given media item, NormalPlays(u,i) is the normalized value for number of plays of the media item by the user, NormalTS(u,i) is the normalized value for time spent listening to the media item by the user, and % TracksPlayed(u,i) is the percentage of tracks played by the user for the media item. W₁, W₁, and W₃ are weighting factors that are heuristically chosen and can be adjusted or learned over time (through machine learning, or trial and error). W_{Age} is a weighting factor that will reduce the value of data for media items that are older as addressed above.

UE(u,i)=(W₁*NormalPlays(u,i)+W₂*NormalTS(u,i)+W₃*% TracksPlayed(u,i))*W_{Age}

While three statistics are mentioned above, persons of ordinary skill in the art will recognize that more or less statistics can be used. For example, user likes or dislikes, skips, purchases, etc. can be used and weighted as described above.

Persons of ordinary skill in the art will recognize that the equation given above is merely illustrative of one way of calculating a user engagement score for a user's engagement with media item but that many other methods are possible and the present technology is not limited to the equation given above.

Once an engagement score has been determined for each media item that the user has engaged with as recorded in the media database in association with their user account, the total scores can be aggregated to determine (218) a compact engagement score for the user.

One way of aggregating the engagement scores for each media item that the user has engaged with it to hash the media item to a hash value according to a locality sensitive hashing function, and the hashed value can be multiplied by the score given to the media item. The multiplied hash values for each media item can then be summed or otherwise aggregated (218) to yield the compact engagement score.

User representation service 118 can receive the taste profile representation from taste profile service 114 and engagement profile representation from engagement services 116, 117 for each user of media service 100 and store these representations in user representation database 120. In some embodiments, user representation service 118 can also determine (220) compact representations for each user that can also be stored in user representation database 120. In some embodiments the compact representations are determined (220) by hashing an aggregated value resulting from combining the taste profile representation and engagement profile representation for each user. Compact representation is a single, easily comparable value for each user of media service 100.

In some embodiments the compact representations are determined (220) by combining weighted values for the taste profile and the engagement profile. For example the compact representation can be represented by the equation below where D=compact representation, P₁=Taste Profile, P₂=Engagement Profile, W₁=first weighting factor, and W₂=second weighting factor.

D=W₁P₁+W₂P₂

The preceding steps addressed above (202-220) and illustrated in FIG. 2 can be performed for each user account of media service 100.

In some embodiments, the preceding steps addressed above (202-220) and illustrated in FIG. 2 are conducted in advance of any request for recommended media items, and can be performed at a scheduled time or at the instruction of an administrator. The steps addressed above (202-220) can be computationally intensive and thus benefit from being perform in advance of being needed to make social recommendations. The result of steps 202-220 can be the generation of the compact representations for each user. The compact representations are contemplated to permit comparisons between many user accounts of media service 100 when requested from a client device as described with respect to the forthcoming steps addressed below (230-238) and illustrated in FIG. 3.

FIG. 3 illustrates an example method of using the compact representations to identify accounts in a social graph having a similar compact representation and recommend media items on the basis of their similarity.

In some embodiments a user device operated by user 102 requests (230) social recommendations from social recommendation service 106.

While in some embodiments, the present technology can be used to compare a first user's compact representation with all other users' compact representations to identify users that have similar representations (and therefore have similar tastes and engagement with media items), in some embodiments, comparisons are limited to within a first user's (e.g., user 102) social network.

Description of FIG. 3 will be made with reference to elements of FIG. 1. Although, the embodiment of FIG. 1 is merely illustrative. Social graph database 130 (FIG. 1) indexes collections of users 104 of media service 100 that have social connections through a social media service. The social media service can be external to media service 100. For example social graph service 132 can be a service of an external social media service, and information from social graph service 132 can be used by media service 100 to determine collections of users 104 of media service 100 that have social connections through that social media service. The social connection can be determined by querying social graph service 132 for social connections for a specific user account, for example user account 102. Social graph service 132 can return all social connections known to that service for user account 102 and media service 100 can determine which of those social connections also have accounts in media service 100, and store the relationship in social graph database 130.

Social recommendations service 106 can perform online processing to provide social recommendations to user account 102. Social recommendations service 106 can request social connections for user 102 from social graph database 130. Upon receiving social connections for user 102 from social graph database 130, social recommendations service can request compact representations for the social connections of user 102, and the compact representation for user account 102. Social recommendations service 106 can compare the compact representation of user account 102 to compact representations for the social connections of user 102 and identify (232) accounts that have a compact representation that are similar to the compact representation of user 102.

In some embodiments, compact representations that are similar are determined by taking the top “n” user accounts that are most similar to the compact representation of user account 102. In some embodiments, compact representations that are similar are determined by taking compact representations that vary by no more than a threshold parameter (e.g., a distance measurement, number of bits, or any other measurement of similarity between two values).

In some embodiments, the compact representations can be stored in user representation database 120 along with social graph information or in accordance with sets of social media groupings.

In some embodiments, rather than identifying (232) accounts at the time media item recommendations are requested by user account 102, it may also be possible to create an inverted index listing all users that have a similar representation for quick look up. The inverted index can be created in advance of request by user account 102 so that when social recommendations service 106 attempts to identify user accounts in user account's 102 social graph, the information can be looked up from the inverted index rather than determined through comparisons of compact representations.

Once accounts have been identified (232) that have a compact representation that is similar to the compact representation of user account 102, social recommendations service 106 can retrieve (234) media items that have been played back by the accounts having a compact representation that is similar to the user account 102. As illustrated in FIG. 1 the retrieved (234) media items can be divided into three different time buckets (T₁, T₂, T₃). One time bucket can be for media items just played back, for example within the last five or 10 minutes. Another time bucket can be for media items played back recently, for example within the last few weeks. The last time bucket can be historical for media items played back further in the past. In some embodiments, only media items that are contained in the just played back and recently played back buckets are returned.

After retrieving (234) the media items, media items that are not relevant to user account 102 are discarded. Media items can be considered not relevant when they belong to a genre that is not represented in the user's taste profile. However, in some embodiments, a criterion to determine whether media items are relevant to user account 102 can be adjusted when too few media items are retrieved (234).

Additionally, in some embodiments, a criterion to determine whether media items are relevant to user account 102 can be relaxed to introduce user account 102 to media items outside of the user account 102's normal preferences. For example, to avoid recommending media items that user account 102 is already playing back regularly (and thus influencing both user account 102's taste profile and engagement profile), social recommendations service 106 can retrieve media items from social connections with a compact representation that is less similar to the compact representation of user account 102 to result in a more diverse selection of media item candidates.

In some embodiments, a user account 102 might have too few user accounts in its social graph to make meaningful recommendations, or user account 102 has enough user accounts in its social graph, but the recommendations are too homogeneous, or there are not enough recommendations. In such embodiments, social recommendations service 106 can compare user account's 102 compact representation to all user accounts' compact representations to recommend other user accounts to follow and add to user account's 102 social graph. In some embodiments, social recommendations service 106 can recommend second degree connections (friends of friends) of user account to follow and add to user account's 102 social graph. In some embodiments, social recommendations service 106 can recommend third or further degree connections (friends of friends of friends) of user account to follow and add to user account's 102 social graph. In some embodiments, rather than recommending additional connections of user accounts to follow, social recommendations service 106 can pull media item recommendations from the additional user accounts without showing the additional connections of user account 102 to the user associated with user account 102.

In such embodiments where user account 102 either has too few connections, or its connections yield to few media item recommendations, social recommendations service 106 can search user representation database 120 to find additional media items to recommend to user account 102. However since user representation database 120 can be quite large and have millions of compact representations, there needs to be an efficient way to search user representation database 120.

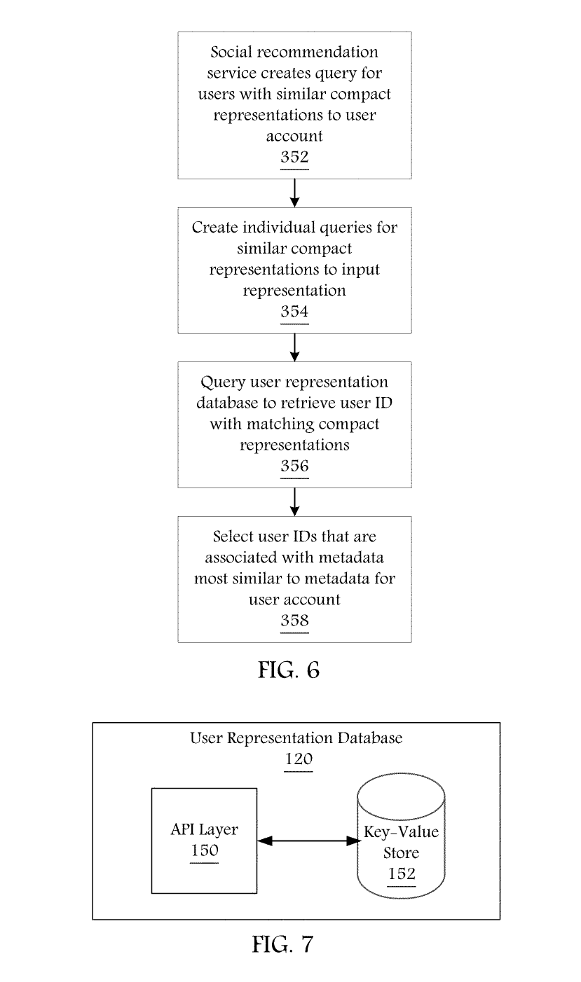

FIG. 6 illustrates a method for efficiently searching user representation database to identify user accounts that have similar compact representations as user account 102 in user representation database 120. The method illustrated in FIG. 6 begins when social recommendations service 106 creates (352) a query for users with similar compact representations to user account. In some embodiments this is accomplished by social recommendations service looking up the compact representation for user account 102 and sending a query to user representation database 120 to find other accounts with a compact representation similar to user account 102.

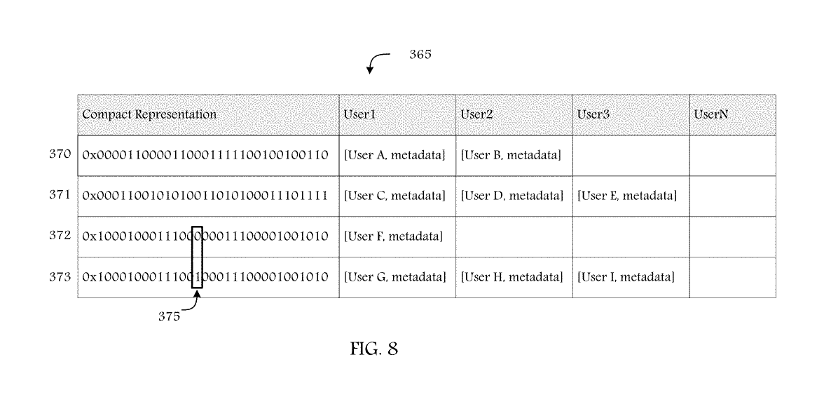

As illustrated in FIG. 7, User representation database 120 can include API layer 150 for receiving queries to the actual database, key-value store 152. In some embodiments key-value store 152 can be a database such as for example Voldemort, or Cassandra, etc., though the present technology is not limited to such databases.

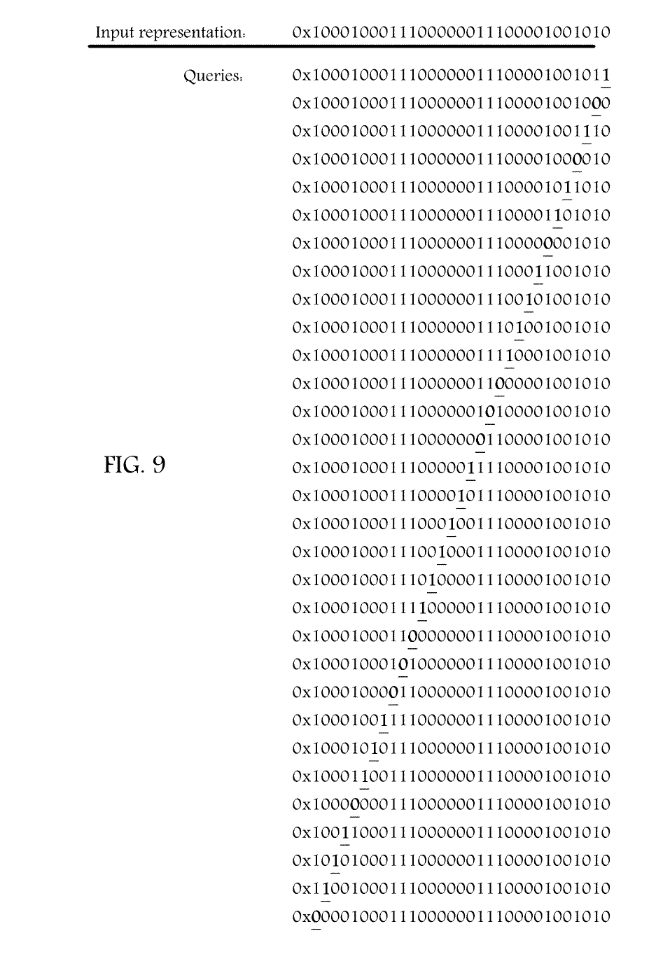

API layer 150 can include logic to receive the compact representation for user account 102 and can create individual queries (354) of key-value store 152 for similar compact representations to the compact representation for user account 102. In some embodiments this can be achieved by identifying specific compact representations to search for that are similar to the compact representation for user account 102. Since, in some embodiments, compact representations can be stored as a 32-bit number as illustrated in FIG. 8, one way to identify specific compact representations to search for is to identify compact representations that differ from the compact representation for user account 102 by only one bit. Therefore for any input 32 bit compact representation there can only be 32 compact representations that differ from the input compact representation by only one bit. FIG. 9 illustrates an input compact representation, and resulting queries. Each query differs from the input compact representation by only one bit at any position.

FIG. 8 illustrates an example logical data structure 365 of user representation database 120 where the compact representations are the keys and user identifiers along with metadata are the values. As illustrated in FIG. 8, some compact representations have more than one user associated with that representation. In other words more than one user of system 100 has the same taste profile. For example, user A, and user B both have the same taste profile represented by the compact representation shown in row 370. Likewise user C, user D, and user E in row 371 all have the same taste profile. However, user F is the only user with the compact representation shown in row 372.

Continuing with the example addressed above, if social recommendations service 106 was not able to identify enough media item recommendations for user 102, (for example, for user F who has no other users with the same taste profile), the process of FIG. 6 can be performed. Referring to FIG. 6, social recommendations service 106 can query 352 user representation database 120 for additional similar taste profiles. API layer 150 can create individual queries (354), where each individual query is a one bit deviation (as seen for example in FIG. 9) from the compact representation shown in row 372 and can query (356) user representation database 120 for each individual query. In some embodiments, the individual queries can be provided or searched in parallel. One such query (356) would be for the compact representation shown in row 373 since that compact representation differs from the compact representation shown in 372 only by the bit shown in box 375. Such a search can be performed extremely quickly, even in such a big database. A search of user representation database 120 containing millions of compact representations might take about 5 milliseconds when performed using the method described in FIG. 6 as compared to seconds or even minutes if the search logic were to search for ranges of possible query results.

For each compact representation found in user representation database 120 that matches the individual queries, user representation database 120 can return (358) the values associated with those user representations, namely the user IDs and associated metadata that corresponds to the keys used in the individual queries. In FIG. 8, this would include user G, user H, and user I.

The metadata associated with each user in user representation database can include a minimal amount of information such as the respective user's top three favorite genres and top three favorite artists. This metadata can be used by social recommendations service 106, to help it rank media item candidates as addressed below. The metadata can be important because, while two representations that are the same except for a one bit difference should reflect similar tastes, some small differences could be substantial to the listener. The metadata can be used to find key similarities between two users, or between the user account and the media item candidates so that the media items recommended to user account 102 are more likely to be good recommendations for user account 102,

In some embodiments, the users identified as a result of the method illustrated in FIG. 6 can be recommended to user 102 to be added to their social network. In some embodiments, the users identified as a result of the clearing method illustrated in FIG. 6 may not be recommended or surfaced to user 102 but the users identified from the query can be used to retrieve additional media item candidates for use by social recommendations service 106.

In some embodiments, media service 100 can retrieve recommendations from second degree connections (friends of friends) of user account by looking up a social graph for a friend in user 102's social graph in social graph database 130. Media items that have been that have been played back by the second degree connection can be added to media item recommendation candidates to be recommended to user account 102.

Whether media item recommendation candidates are identified from user accounts in user 102's social network having a similar taste profile as user 102, or media item recommendation candidates are retrieved from a broader collection of users (further degrees of separation in user 102's social graph, or users outside of user 102's social graph but that have a similar compact representation as user 102), the media item candidates can be ranked (236) according to a ranking criterion. Ranking criteria can include:
how relevant a media item is to user account 102's social network (e.g., how many user accounts user account 102's social network have played back the media item)
how relevant a media item is to user account 102 such as metadata stored in user representation database 120, for example top three genres and top three artists (e.g., user account 102 has played back the media item, the media item belongs to a favorite genre of user account 102, the media item belongs to a favorite artist of user account 102, or the user account as declared the media item a favorite or liked)
how recently the media item has been played back
how popular the media item in (e.g., the media item appears in a top chart or editors list)
how often the media item has been played back user 102's social network
a diversity factor (some media items that are not strongly relevant to user 102 are weighted more strongly to introduce diversity into the media item recommendations.

After the media items have been ranked social recommendations service 106 can present (238) the retrieved media items in a user interface on a client device associated with the user account 102 ordered from highest rank to lowest. In some embodiments, only a certain number of highest ranked media items will be presented (238) in the user interface.

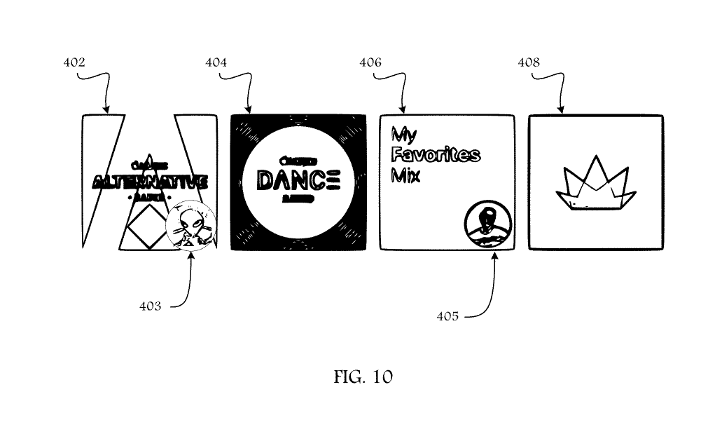

In some embodiments, the client device associated with the user account 102 can request badges from badge service 134 representing users of user account 102's social network that have recently played back the media items presented (238) to be displayed over the representations of the presented media items. For example FIG. 10 illustrates recommended media items 402, 404, 406, and 408 with badge 403 on media item 402, and badge 405 on media item 406. A badge can be a representation or picture associated with a user account. Accordingly, badge 403 indicates that the user account associated with that badge recently played back media item 402, and badge 405 indicates that the user account associated with that badge recently played back media item 406.

In some embodiments, the media items having the highest ranks can be combined into a playlist and presented as a media item in the user interface on the client device associated with the user account 102.

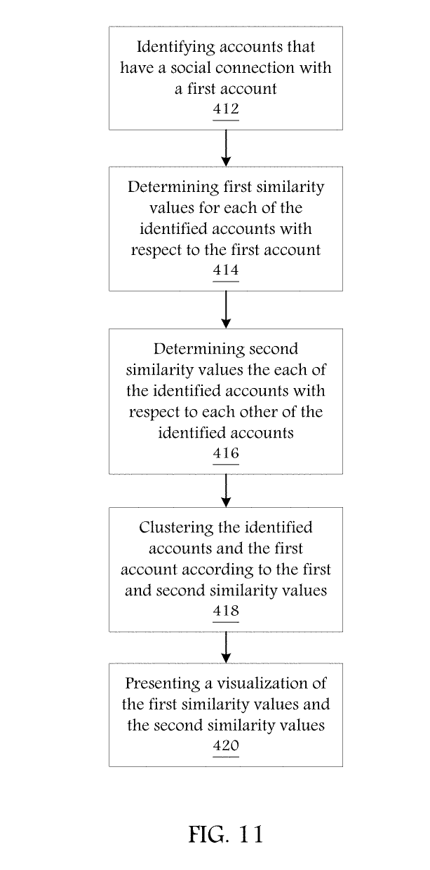

FIG. 11 illustrates an example method for visualizing the amount of influence each user account in a social network has other user accounts in the social network. In some embodiments a social graph visualization service can identify (412) accounts that have a social connection with a first user account (e.g., user account 102). The social graph visualization service can determine (414) similarity values for each of the identified accounts with respect to the first account and determine (416) similarity values for each of the identified accounts that have a social connection with the first user account with respect to each other.

Based on the similarity values, the social graph visualization service can cluster (418) the identified accounts and the first account according to the similarity values and present (420) the visualization of the of the first user and the identified accounts that have a social connection arranged according to their similarity values.

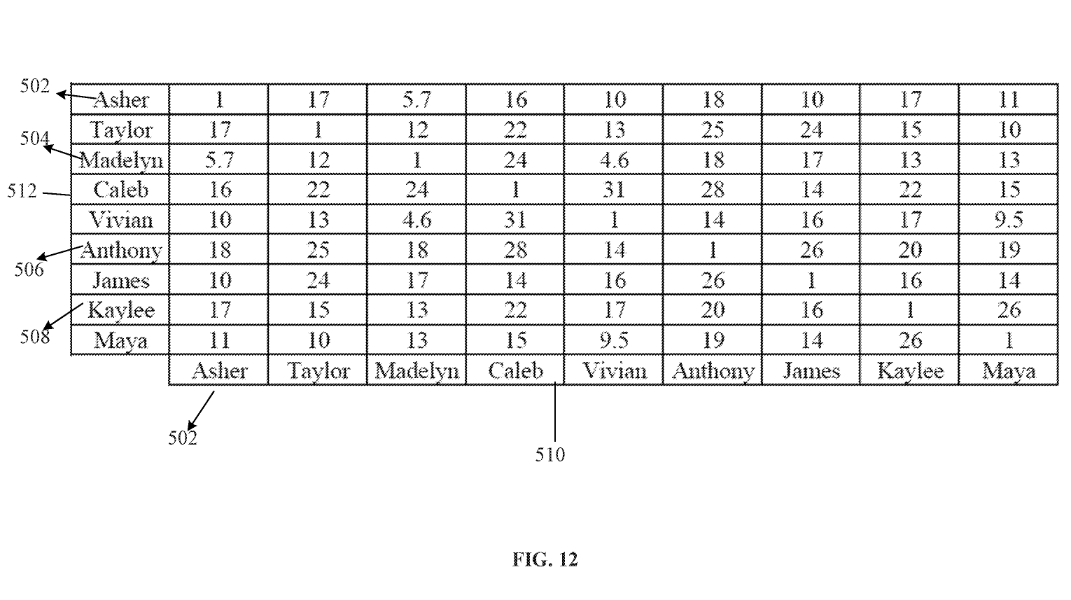

FIG. 12 illustrates one such visualization of the first user and the identified accounts that have a social connection to the first user, and their respective similarity values. FIG. 12 illustrates a matrix having an x-axis of user accounts and the y-axis of the same user accounts. The X and Y values intersect at a distance representation indicative of the similarity of the compact representation of the user account represented in the x-axis compared to the compact representation of the user account represented in the y-axis. For example, Asher 502 is the first user and all other uses represented in X 510 and Y 512 axes are other user account in Asher 502's social graph.

The matrix shows that Asher 502 has a relatively similar representation as to Madelyn 504, wherein the matrix reflects a distance representation of 5.7 between the two user accounts. This is in contrast with Anthony 506 and Kaylee 508 for which the matrix reflects a distance representation of 18 and 17 respectively between these user accounts and Asher 502.

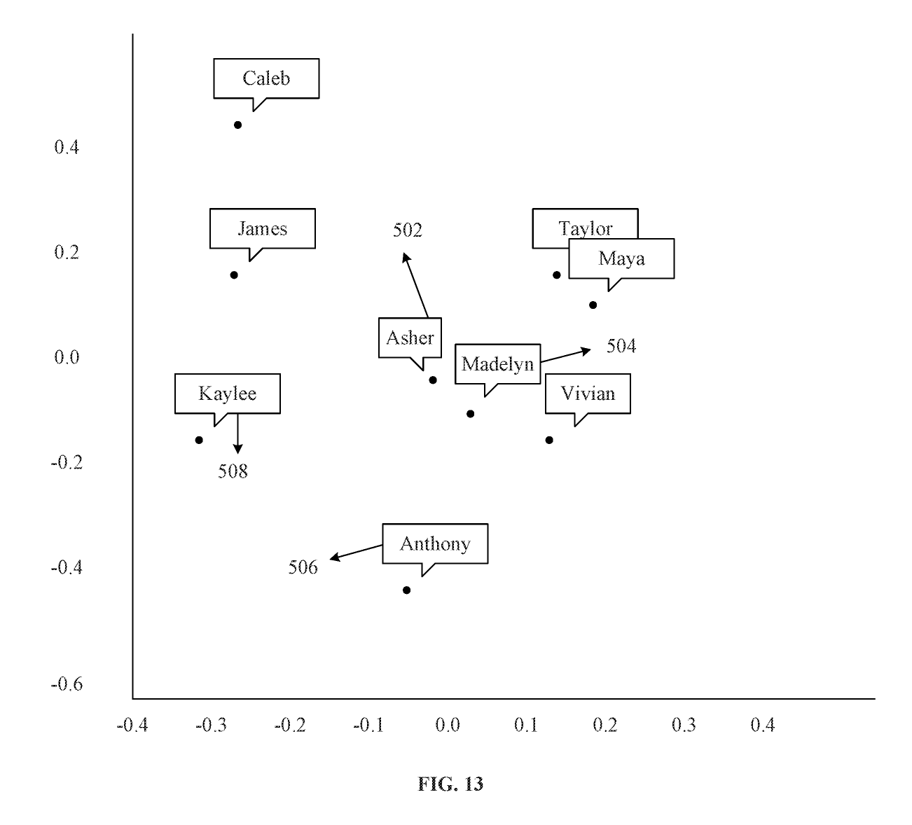

These distance representations are further reflected in FIG. 13. FIG. 13 illustrates a map of the relative similarity between the compact representations associated with each user account with respect to Asher 502. Asher 502 is shown in the middle of the map Madelyn 504 is also shown in the middle the map close to Asher 502. The relative close orientation of Asher 502 and Madelyn 504 is reflective of the relatively small distance representation of 5.7 shown in the matrix illustrated in FIG. 11. In contrast Kaylee 508 and Anthony 506 are shown toward the edges of the map which reflect the relatively larger distance representation for these user accounts as compared to Asher 502. FIG. 12 not only shows the relative distance representations of each user account with respect to Asher 502 but also shows the relative similarity in the representations of other user accounts as the closer one user account is to another the more similar the accounts compact representations are.

In the embodiments addressed above with respect to FIG. 12 and FIG. 13, the relative similarity between each pair of users is represented in a 2-dimensional space, but these visualizations are projections from a 32-dimensional (64 or 128 dimensional) space where each dimension represents one factor making up a representation of a user account's representation. It should be appreciated that this many-dimensional space can be mapped to any smaller dimensional space. For example, it may be possible to project a relative similarity between pairs of users into a 3-dimensional (or higher) dimensional space.

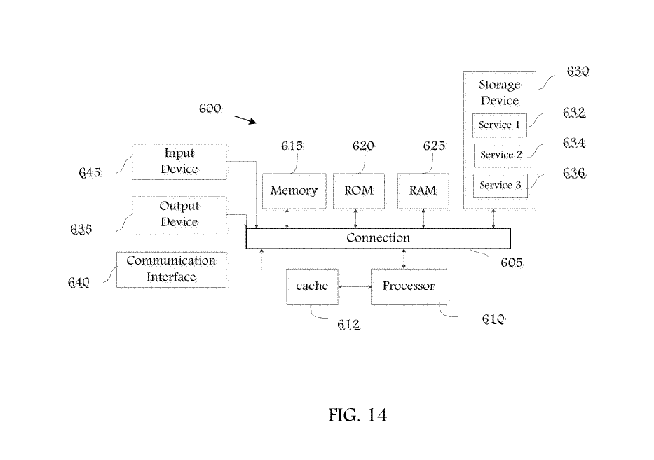

FIG. 14 shows an example of computing system 600. Computing system 600 can represent components of a user device or computing platform. Computing system 600 can be a smart phone, laptop, desktop, or server. Computing system 600 can run any of the services described herein. In some embodiments, each service can be a separate computing system 600. In some embodiments, computing system 600 can be a distributed system. In computing system 600 in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read only memory (ROM) and random access memory (RAM) to processor 610. Computing system 600 can include a cache of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A non-transitory computer readable medium comprising instructions stored thereon that when executed cause a computing system to:
determine compact representations for each of a plurality of accounts of an online media distribution service, each of the compact representations being representative of a respective account's media taste including the respective account's affinity for at least one genre, and the respective account's media playback history; and
identify accounts from the plurality of accounts that have a respective compact representation that is similar to a first compact representation for a first account of the plurality of accounts.

2. The non-transitory computer readable medium of claim 1, wherein the instructions to identify accounts from the plurality of accounts that have a respective compact representation that is similar to the first compact representation is performed in in response to a request from a user account.

3. The non-transitory computer readable medium of claim 1 comprising instructions that when executed cause the computing system to:
retrieve media items played back by the accounts that have a respective compact representation that is similar to the first compact representation; and
cause transmission of the retrieved media items for presentation in a user interface associated with the first account.

4. The non-transitory computer readable medium of claim 3, wherein the retrieved media items include media items from just-played collections, and recently-played collections from the accounts that have a respective compact representation that is similar to the first compact representation, wherein the just-played collections includes media items played back within a threshold period, and
wherein the instructions cause the computing system to rank the retrieved media items according to a ranking criteria, the ranking criteria including a preference for media items retrieved from the just-played collections, whereby media items played back within the threshold period by the accounts that have a respective compact representation that is similar to the first compact representation are prioritized for presentation to the first account.

5. The non-transitory computer readable medium of claim 1, wherein the instructions to determine the compact representations for each of the plurality of accounts of the online media distribution service includes instructions to:
analyze playback histories for each of the plurality of accounts to identify media items played back by each respective account, for each of the media items played back map the media item's genre and artist to a score;
analyze the playback histories for each of the plurality of accounts to determine an adventurousness ranking for each of the plurality of account and map the adventurousness ranking to a score; and
aggregate all scores for each respective account of the plurality of accounts to yield a representation of the respective account's media taste.

6. The non-transitory computer readable medium of claim 5, wherein prior to aggregating all scores, adjust the score for each media item's genre and artist by a decay factor, thereby reducing influence of older media items of the representation of the respective account's media taste.

7. The non-transitory computer readable medium of claim 1 wherein the instructions to determine the compact representations for each of the plurality of accounts of the online media distribution service includes instructions to:
analyze playback histories for each of the plurality of accounts to identify media items played back by each respective account, for each of the media items played back identify a play count and time spent playing back the respective media item;
derive an engagement score for each media item from the play count and time spent playing back the respective media item; and
aggregate the engagement scores derived for each media item to yield a compact engagement score for the user account.

8. The non-transitory computer readable medium of claim 1, wherein the identification of accounts having a compact representation that is similar to a first compact representation of a first account, includes instructions to identify accounts within a social network of the first account.

9. A system for providing socially influenced recommendations, the system comprising:
at least one storage device comprising a user account representation database;
at least one processor configured to perform at least a network engagement service and to perform a social recommendations service, the social recommendation service in communication with the user account representation database, and the network engagement service, the social recommendations service configured to:
query the user account representation database for an identification of accounts having a compact representation that is similar to a first compact representation of a first account;
request, from the network engagement service, media items played back by the accounts having the compact representation that is similar to the first compact representation; and
receive, from the network engagement service, identification of the media items.

10. The system for providing socially influenced recommendations of claim 9, wherein the social recommendations service is configured to:
cause presentation of the retrieved media items in a user interface associated with the first account.

11. The system for providing socially influenced recommendations of claim 9, wherein the received media items include media items from just-played collections, and a recently-played collections from the accounts having the compact representation that is similar to the first compact representation, wherein the just-played collections includes media items played back within a threshold period, and the recently-played collections include media item played back outside the threshold.

12. The system for providing socially influenced recommendations of claim 11, wherein the social recommendations service is configured to:
rank the received media items according to a ranking criteria, the ranking criteria including a preference for the media items retrieved from the just-played collections.

13. The system for providing socially influenced recommendations of claim 12, wherein the social recommendations service is configured to:
cause presentation of the retrieved media items in a user interface associated with the first account, the retrieved media items being arranged in the user interface according to rank.

14. The system for providing socially influenced recommendations of claim 9, wherein the media items are selected from the group consisting of: albums and playlists.

15. The system for providing socially influenced recommendations of claim 9, wherein the identification of accounts having a compact representation that is similar to a first compact representation of a first account, includes instructions to identify accounts within a social network of the first account.

16. The system for providing socially influenced recommendations of claim 9, wherein the identification of accounts having a compact representation that is similar to a first compact representation of a first account, includes instructions to find accounts having a compact representation that differs by a single bit representation from the first compact representation of the first account.

17. A method comprising:
identifying accounts that have a social connection with a first account;
determining first similarity values for each of the identified accounts with respect to the first account;
determining second similarity values the each of the identified accounts with respect to each other of the identified accounts; and
presenting a visualization of the first similarity values and the second similarity values.

18. The method of claim 17, wherein the visualization is a map of each of the identified accounts and the first account distributed in a space according to the first and second similarity values, whereby the identified accounts that are most similar to the first account are represented in a closer distance than the identified accounts that are less similar to the first account.

19. The method of claim 17, wherein the visualization is a map of each of the identified accounts and the first account distributed in a space according to the first and second similarity values, whereby the identified accounts that are most similar to each other are represented in clusters.

20. The method of claim 17, wherein the presenting the visualization of the first similarity values and the second similarity values comprises:
clustering the identified accounts and the first account according to the first and second similarity values.
